(19) United States
(12) Patent Application Publication
(10) Pub. No.: US 2025/0323296 A1
(43) Pub. Date: Oct. 16, 2025

(54) CONTROL SYSTEM FOR CONTROLLING A FUEL CELL SYSTEM

(71) Applicant: PowerCell Sweden AB, Gothenburg (SE)

(72) Inventors: Per BJÖRE, Gothenburg (SE); Andreas BODÉN, Sävedalen (SE); Richard BERKLING, Saro (SE)

(21) Appl. No.: 18/811,226

(22) Filed: Aug. 21, 2024

(30) Foreign Application Priority Data
Apr. 10, 2024 (SE) 2430193-9

(51) Int. Cl. H01M 8/04694; H01M 8/249

(52) U.S. Cl. CPC H01M 8/04694; H01M 8/249

(57) ABSTRACT

A control system for controlling a fuel cell system is provided, wherein the fuel cell system comprises a plurality of sub-units. The control system comprises a control unit being configured to control each of the sub-units individually.

The present invention relates to a control system for controlling a fuel cell system according to claim 1.

A fuel cell system can provide power to any kind of application. Such a fuel cell system can consist of several fuel cell stacks and can be a power plant or the like. A fuel cell system can also consist of several fuel cell stack systems (for example power plants) each comprising one or more fuel cell stacks. In any case, such a fuel cell system needs to be controlled to provide a specific power which is required for the corresponding application. Nowadays, a master controller is typically implemented which controls the fuel cell system in its entirety. The individual features and characteristics of sub-units (such as fuel cell stacks or fuel cell stack systems) of the fuel cell system are not considered when controlling the fuel cell system.

It is therefore object of the present invention to provide an improved control of a fuel cell system which is able to consider the individual sub-units of a fuel cell system.

This object is solved by a control system for controlling a fuel cell system according to claim 1.

As mentioned above, a fuel cell system comprises a plurality of sub-units. These sub-units can each be a fuel cell stack, in which case the fuel cell system can be for example a vehicle, a ship, a train, a plane or any other kind of fuel cell stack system. Alternatively, the fuel cell system can comprise a plurality of fuel cell stack systems, for example a power plant, wherein each fuel cell stack system comprises one or more fuel cell stacks. Also, a combination of sub-units being single fuel cell stacks and being fuel cell stack systems is possible.

In order to provide an improved control of the fuel cell system, the proposed control system comprises a control unit being configured to control each of the sub-units individually. Thus, instead of controlling the fuel cell system in its entirety, i.e., providing the same control to each sub-unit, the herein described control unit is able to provide an individual control command to each sub-unit. This provides the advantage that the specific features and characteristics of each sub-unit can be considered, and the control unit can address and control each sub-unit individually, for example based on the specific features and characteristics. Thus, at the same time, the control unit can control the entire fuel cell system (via control of the individual sub-units) and each sub-unit individually, for example with respect to the total power output and the individual power output.

In existing systems, a main controller was configured to provide the same control command to each sub-unit, i.e., each sub-unit was controlled to do the same: all have the same power level, all are switched off, none is switched off, etc. In contrast to that, the herein proposed control unit is able to provide a different control command to each sub-unit which means that the sub-units may operate differently: each sub-unit may have a different power level, some may be switched off and some may be switched on, etc. Further, the control unit may also change the individual control over time, i.e., may change the operation of the sub-units individually over time. This individual control provides a more flexible and comprehensive control of the single sub-units and thus of the whole fuel cell system.

According to an embodiment, the control unit is integrated into one of the sub-units. In this case, one control unit may be provided, and this one control unit is integrated into one sub-unit. Such an arrangement may provide the advantage that no additional control unit is required which would be arranged somewhere separate to the sub-units. Further, the integrated control unit may have a direct insight into the operation and function of the sub-unit and thus of the whole fuel cell system.

According to a further embodiment, the control system comprises a plurality of control units, wherein at least one sub-unit comprises one of the plurality of control units. When more control units are provided in the control system, this may provide a control redundancy to the system and thus may reduce or eliminate the failure of the overall system. This means that, when one of the control units fails, the other control units may assume the control of the failed control unit.

According to a further embodiment, each sub-unit comprises one of the plurality of control units. On one hand, the control units may control the respective sub-unit in which the control unit is integrated. On the other hand, at least one of the control units may additionally control the entire fuel cell system.

Such an implementation of the control units may provide the advantage that the fuel cell system may be variably scalable, in upwards and in downwards direction. When a sub-unit is removed from the fuel cell system (for example for maintenance), it is irrelevant whether this sub-unit has a control unit as each of the remaining sub-units also has a control unit so that the control functionality can still be provided and upheld in the remaining components of the fuel cell system as there remain control units in the fuel cell system due to the other sub-units. Further, the manufacturing of the fuel cell system may be facilitated as the sub-units are the same and can thus be manufactured in greater number, i.e., reducing the manufacturing costs.

In addition to the control units in one or more of the sub-units, one of the plurality of control units may be provided as separate control unit, independently from the sub-units. This separate control unit may be connected upstream of the control units of the sub-units and may serve as a kind of superordinate control unit. However, also in this case, as there are several control units present in the fuel cell system, this provides a control redundancy to the overall system, thus reducing the risk of a failure of the control of the fuel cell system. Further, on the fly maintenance is possible as one or more of the sub-units can be powered down and maintained without influencing the control of the entire system, but only the maximum available power output.

According to a further embodiment, the control system is configured to assign the functionality of a master control unit to one of the plurality of control units, wherein the other control units of the plurality of control units have the functionality of slave control units. According to this embodiment, one of the control units is the master control unit, i.e. the control unit being responsible for the control of the entirety of the fuel cell system. As one control unit is the designated master control unit, conflicting control commands from different control units may be avoided.

The remaining control units, i.e. the slave control units, may provide supporting control functionality, for example by controlling the sub-unit in which the respective slave control unit is implemented. However, such a supporting control functionality will be controlled by the master control unit in order to avoid conflicting control commands as mentioned above. Thus, the master control unit is configured to provide control commands to each sub-unit individually so that each sub-unit can individually operate, independent on the remaining sub-units. Further, the master control unit may provide the control commands for each sub-unit to the respective slave control unit being integrated in the respective sub-unit and the slave control units may be responsible to implement the control commands of the master control unit in the respective sub-unit.

According to a further embodiment, the control system is further configured to re-assign the functionality of a master control unit by switching the control unit being assigned the functionality of the master control unit to the functionality of a slave control unit and by assigning the functionality of the master control unit to another control unit. Thus, the control system may decide which of the control units should act as master control unit and may assign the functionality correspondingly and may also change the assignation.

The control system may thus be configured to actively select one of the control units as master control unit, either assigning the functionality at the beginning of the operation of the control system or re-assigning the functionality during the runtime of the control system. The active selection may be based on different factors, for example characteristics of the individual sub-units, characteristics of the whole fuel cell system, or a combination of these.

Alternatively, the control system may be configured to passively select one of the control units as master control unit. For example, this latter implementation may be advantageous when the current master control unit fails or goes offline, or the corresponding sub-unit goes offline and thus also the associated master control unit goes offline. In this case, another control unit may automatically be promoted from a slave control unit to the master control unit, i.e., the functionality of one of the slave control units will be changed automatically and/or passively from slave to master. This provides an easy way of a failover control of the control system. Such a failover control is possible as long there is more than one control unit implemented in the control system.

For assigning the functionalities of master and slave, the control system needs to be able to address the control units. For example, each control unit may have a unique identifier, which can be assigned during installation or can be assigned later dynamically. The control system may then be configured to select one of the control units as master control unit based on the unique identifier. For example, when starting the control system, the control unit having the lowest unique identifier may be selected as the master control unit. When the master functionality is to be re-assigned, for example when the selected master control unit fails, the control unit having the second lowest unique identifier may be selected as new master control unit. Any other kind of selection based on the unique identifier may be used, for example from the highest unique identifier descending, or a random choice of the unique identifier. Further, the unique identifier may also be used for actively selecting one of the control units based on other selection criteria, such as characteristics of the sub-units.

For further improving the control of the fuel cell system, the control units may be configured to receive parameters from the fuel cell system including parameters from the plurality of sub-units and are configured to control each sub-unit individually based on the received parameters. In particular, the master control unit is configured to receive the respective parameters and to control the sub-units according to these received parameters. Thus, the control system does not only provide an individual control of the individual sub-units but does also provide an improved control considering parameters of the sub-units and/or the fuel cell system. This is the case as the individual control of the sub-units may be adjusted according to the individual features and characteristics. The control system may thus for example enhance the lifetime of the overall fuel cell system as the sub-units may be operated under consideration of their individual constraints.

When a new sub-unit is installed into the fuel cell system (for example for replacing a failed sub-unit or for increasing the overall power), this sub-unit may send its parameters to the (master) control unit. Thus, the control of the fuel cell system may consider the individual characteristics of a sub-unit also directly after installation of a new sub-unit.

The parameters of the sub-units may be for example a minimum power level of the sub-unit, an efficiency of a sub-unit, a start-up or shut-down time of a sub-unit, a health state of a sub-unit, a durability of a sub-unit, a ramp rate of a sub-unit, an availability of sub-unit, etc. Further, the same parameters may also be provided as parameters of the overall fuel cell system. The control unit may consider these parameters, or a combination of these parameters, when controlling the sub-units and the entire fuel cell system.

The control unit may also consider the combined available power (i.e., the power providable by all sub-units together) as a parameter of the fuel cell system. Moreover, this combined available power may also be communicated to an operator of the fuel cell system.

Further, the control unit may receive a demand for a specific power level from an operator of the fuel cell system and may control the sub-units not only based on their individual features and characteristics, but also based on such a power demand. The control unit may further be configured to control each of the sub-units for optimizing different parameters of the individual sub-units and/or the entire fuel cell system. These optimization parameters may be for example increase of the lifetime of a sub-unit, increase of the efficiency of a sub-unit and/or the entire fuel cell system, increase of a ramp rate capability of the fuel cell system, recurring regeneration of a sub-unit, minimum available burst power of a sub-unit, startup and shutdown time of a sub-unit and/or the entire fuel cell system, increase of the accumulated runtime of the fuel cell system, etc.

Thus, the (master) control unit may consider the condition or state of each sub-unit for enhancing the operation of each single sub-unit and enhancing the operation of the entire fuel cell system at the same time, for example with respect to the lifetime, available power or the like, or a combination of the different parameters and optimization parameters as mentioned above.

A further aspect of the present invention relates to a control method for controlling a fuel cell system. The method comprises the step of controlling each sub-unit of the fuel cell system individually.

The features as described with respect to the control system also applies to the features of the control method.

An even further aspect of the present invention relates to a computer program product comprising a computer program code which is adapted to prompt a control unit, e.g. a computer, and/or a computer of the above discussed control system to perform the above discussed steps.

The computer program product may be a provided as memory device, such as a memory card, USB stick, CD-ROM, DVD and/or may be a file which may be downloaded from a server, particularly a remote server, in a network. The network may be a wireless communication network for transferring the file with the computer program product.

Further preferred embodiments are defined in the dependent claims as well as in the description and the figures. Thereby, elements described or shown in combination with other elements may be present alone or in combination with other elements without departing from the scope of protection.

In the following, preferred embodiments of the invention are described in relation to the drawings, wherein the drawings are exemplarily only, and are not intended to limit the scope of protection. The scope of protection is defined by the accompanied claims, only.

The figures show:

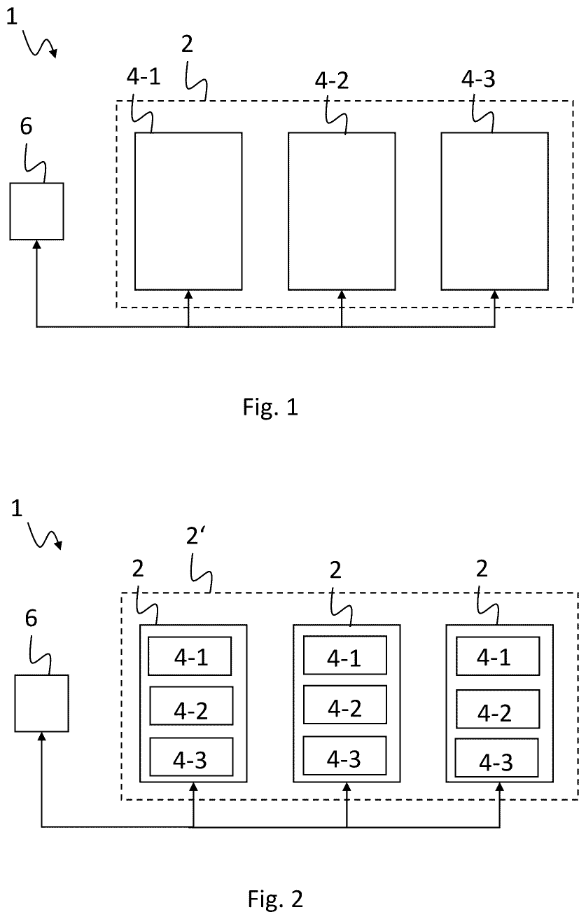

FIG. 1: a schematic block diagram of a first embodiment of a control system for controlling a fuel cell system;

FIG. 2: a schematic block diagram of a second embodiment of a control system for controlling a fuel cell system

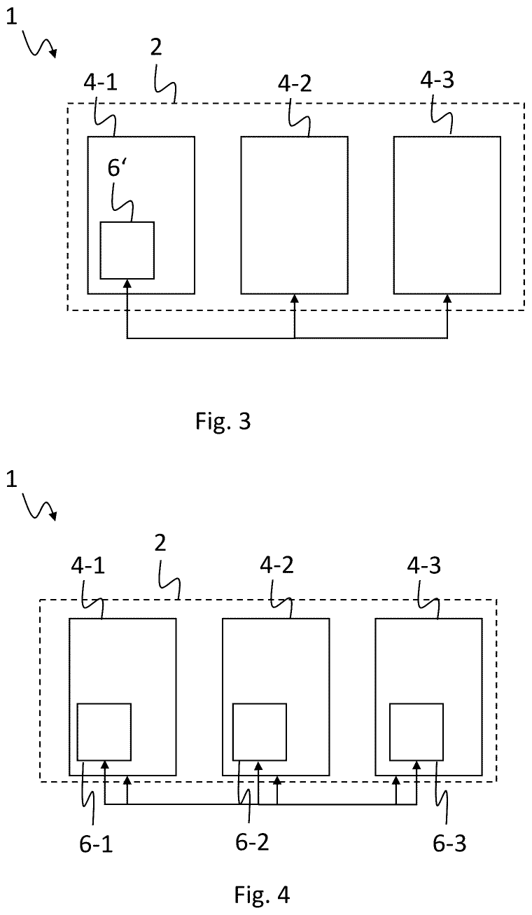

FIG. 3: a schematic block diagram of a third embodiment of a control system for controlling a fuel cell system;

FIG. 4: a schematic block diagram of a fourth embodiment of a control system for controlling a fuel cell system; and

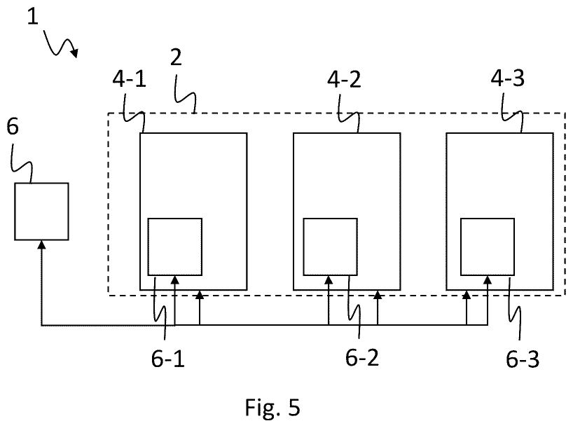

FIG. 5: a schematic block diagram of a fifth embodiment of a control system for controlling a fuel cell system.

In the following same or similar functioning elements are indicated with the same reference numerals.

FIG. 1 shows a control system 1 for a fuel cell system 2. The fuel cell system 2 comprises a plurality of sub-units 4-1, 4-2, 4-3. The sub-units 4-1, 4-2, 4-3 may be for example fuel cell stacks which are each configured to provide an individual power. The fuel cell system 2 comprising the plurality of fuel cell stacks can be a power plant. The single sub-units 4-1, 4-2, 4-3 can also be a power plant having a plurality of fuel cell stacks. Thus, the fuel cell system 2 as described in the following can also be built in a cascading way, wherein each sub-unit 4-1, 4-2, 4-3 can be part of a fuel cell system 2 which itself is arranged within a superior fuel cell system 2′ as shown in FIG. 2. The following described embodiments may be applied to a fuel cell system 2 as well as a fuel cell system 2′ with fuel cell systems 2 as sub-units.

As shown in FIG. 1, the control system 1 comprises a control unit 6. In existing fuel cell systems, it was common to have a control unit for controlling all sub-units simultaneously in the same manner. Thus, each sub-unit was controlled to operating the same way, without any individual consideration of the state or condition of such a sub-unit.

In contrast to such a conventional control unit, the herein described control unit 6 is able to control each sub-unit 4-1, 4-2, 4-3 individually. This individual control can be based for example on specific parameters and characteristics of each sub-unit 4-1, 4-2, 4-3. The specific parameters and characteristics can reflect the state and condition of each sub-unit 4-1, 4-2, 4-3, for example in view of lifetime, available power, efficiency, minimum or maximum available burst power, startup and shutdown time, etc. In addition, the control unit 6 can control the entire fuel cell system 2 via control of the individual sub-units 4-1, 4-2, 4-3. In particular, the control unit 6 is configured to control the entire fuel cell system 2 for providing a power which is requested by an operator and/or the application in which the fuel cell system 2 is implemented. However, in contrast to previous systems, the control unit 6 can consider the individual characteristics of the sub-units 4-1, 4-2, 4-3 so that each sub-unit 4-1, 4-2, 4-3, and the entire fuel cell system 2, can be operate under optimized conditions.

When the operator requests a specific power output, the control unit 6 can decide how to provide this requested power output. For example, the control unit 6 can select sub-units 4-1 and 4-2 to operate with maximum power output whereas sub-unit 4-3, which has a reduced lifetime compared to the other sub-units 4-1, 4-2, is controlled to operate with a reduced power output for enhancing the lifetime of the sub-unit 4-3. Any other optimization considerations for providing an optimized operation of the sub-units 4-1, 4-2, 4-3 and the fuel cell system 2 itself whilst providing a requested power output are possible.

It should be noted that each sub-unit 4-1, 4-2, 4-3 may have its own controller (not shown) for controlling the operation of the sub-unit 4-1, 4-2, 4-3. Such a controller may receive control commands from the control unit 6 for controlling the operation of the respective sub-unit 4-1, 4-2, 4-3.

As shown in FIG. 1, the control unit 6 can implemented as separate control unit 6, outside of the fuel cell system 2. In an alternative embodiment as shown in FIG. 3, the control unit 6′ can be implemented as part of one of the sub-units 4-1, 4-2, 4-3, in this case sub-unit 4-1. The control unit 6′ may act as control unit for controlling all sub-units 4-1, 4-2, 4-3 and the entire fuel cell system 2 and may additionally provide the functionality of the controller of the sub-unit 4-1 for directly controlling the operation of the sub-unit 4-1.

In a further embodiment as shown in FIG. 4, each of the sub-units 4-1, 4-2, 4-3 can comprise a control unit 6-1, 6-2, 6-3. Alternatively, some of the sub-units 4-1, 4-2, 4-3 can comprise a control unit 6-1, 6-2, 6-3. One of the control units 6-1, 6-2, 6-3 is the master control unit. For example, control unit 6-1 has the functionality of the master control unit, i.e., is responsible for controlling the operation of the fuel cell system 2 via the sub-units 4-1, 4-2, 4-3. The remaining control units 6-2, 6-3 have the functionality of slave control units, i.e., are a kind of back-up control unit in case the master control unit 6-1 fails or the like.

Such an implementation of the control unit 6-1, 6-2, 6-3 provides the advantage that each sub-unit 4-1, 4-2, 4-3 is identical having a control unit 6-1, 6-2, 6-3 and can thus be easily replaced without influencing the operation of the fuel cell system 2. For example, when the sub-unit 4-1 having the current master control unit 6-1 is shutdown, removed or fails for other reasons, and thus the master control unit 6-1 also fails, the role of the master control unit can be passed to any other control unit 6-2, 6-3 of the remaining sub-units 4-2, 4-3, for example the control unit 6-2 is promoted to be the master control unit. Thus, having a plurality of control units 6-1, 6-2, 6-3 provides a redundancy of the control within the control system 1. Such a redundancy allows for a scalable fuel cell system 2 (in upward and downward direction) in which sub-units 4-1, 4-2, 4-3 can be arbitrarily removed and added, as the control unit 6-1, 6-2, 6-3 of each sub-unit 4-1, 4-2, 4-3 could serve as master control unit when necessary. Further, the redundancy allows for a flexible maintenance of the individual sub-units 4-1, 4-2, 4-3 as each sub-unit 4-1, 4-2, 4-3 can be shutdown when necessary for the same reasons.

As shown in FIG. 5, the control unit 6 (arranged outside the fuel cell system 2) and the control units 6′, 6-1, 6-2, 6-3 can be combined. In this case, the control unit 6 may serve as master control unit and the control units 6-1, 6-2, 6-3 may serve as slave control units, providing backup in case of a failure of the control unit 6.

As illustrated in the figures, each of the control units 6, 6′, 6-1, 6-2, 6-3 is configured to communicate with the other control units 6, 6′, 6-1, 6-2, 6-3 as well as the sub-units 4-1, 4-2, 4-3. The communication link (which can be wired or wireless) may be used for sending control commands as well as for receiving parameters or for sending/receiving any other kind of information, as described above.

It should be noted that the above-described embodiments of FIGS. 1 to 5 can be combined in any suitable manner. For example, the cascading arrangement of FIG. 2 may also be implemented in the arrangements of FIGS. 3 to 5.

In summary, the herein disclosed control system provides a flexible and optimized control of a fuel cell system as each sub-unit can be controlled individually, taking into account specific parameters and characteristics of the individual sub-units.

### REFERENCE NUMERALS

1 Control system
2 Fuel cell system
2′ Superior fuel cell system
4-1, 4-2, 4-3 Sub-unit
6, 6′, 6-1, 6-2, 6-3 Control unit

1. A control system for controlling a fuel cell system, wherein the fuel cell system comprises a plurality of sub-units,
the control system comprising a control unit being configured to control each of the sub-units individually.

2. The control system according to claim 1, wherein the control unit is integrated into one of the sub-units.

3. The control system according to claim 1, wherein the control system comprises a plurality of control units, wherein at least one sub-unit comprises one of the plurality of control units.

4. The control system according to claim 3, wherein each sub-unit comprises one of the plurality of control units.

5. The control system according to claim 3, wherein one of the plurality of control units is provided as separate control unit, independently from the sub-units.

6. The control system according to claim 3, wherein the control system is configured to assign the functionality of a master control unit to one of the plurality of control units, wherein the other control units of the plurality of control units have the functionality of slave control units.

7. The control system according to claim 6, wherein the control system is further configured to re-assign the functionality of a master control unit by switching the control unit being assigned the functionality of the master control unit to the functionality of a slave control unit and by assigning the functionality of the master control unit to another control unit.

8. The control system according to claim 1, wherein the control system is configured to actively select one of the control units as master control unit.

9. The control system according to claim 1, wherein the control system is configured to passively select one of the control units as master control unit.

10. The control system according to claim 1, wherein each control unit has a unique identifier, and wherein the control system is configured to select one of the control units as master control unit based on the unique identifier.

11. The control system according to claim 1, wherein the control units are configured to receive parameters from the fuel cell system including parameters from the plurality of sub-units and are configured to control each sub-unit individually based on the received parameters.

12. The control system according to claim 11, wherein the parameters are at least one of an efficiency, durability, minimum power level, ramp rate, availability, redundancy, combined available power.

13. The control system according to claim 1, wherein the control unit is configured to control each of the sub-units for optimizing at least one of fuel cell stack lifetime, efficiency, ramp rate capability, recurring regeneration of a fuel cell stack, minimum available burst power, startup and shutdown time, state of health, and accumulated runtime.

14. The control system according to claim 1, wherein each of the sub-units comprises at least one fuel cell stack.
